(19) United States
(12) Patent Application Publication
(10) Pub. No.: US 2009/0091440 A1
(43) Pub. Date: Apr. 9, 2009

(54) Brake light with pre-brake warning

(76) Inventor: Kendyl A. Roman, Sunnyvale, CA (US)

Correspondence Address: KENDYL A ROMAN, 730 BARTEY COURT, SUNNYVALE, CA, 94087, US

(21) Appl. No.: 12/287,635

(22) Filed: Oct. 9, 2008

Related U.S. Application Data
(60) Provisional application No. 60/998,418, filed on Oct. 9, 2007.

(51) Int. Cl. B60Q 1/44

(52) U.S. Cl. 340/479

(57) ABSTRACT

An improved brake light warning system is provided that warns the driver of an intelligent vehicle of the need to brake while simultaneously alerting the driver of a following car prior to the driver of the intelligent vehicle stepping on the brakes. A highly intelligent vehicle processor monitors inputs from various sources and compares the reactions of the driver of the highly intelligent vehicle to that of a virtual competent driver in the same context. In response to the presence of an obstacle, the leading car may brake or decelerate. The highly intelligent vehicle detects the response of the leading car via a remote sensing device and sends a pre-brake signal to the brake light assembly that comprises a pre-brake indicator, a brake indicator, and optionally a reverse indicator, and/or a turn indicator. The pre-brake indicator of the brake light assembly illuminates and is observable by the driver of following car.

### RELATED APPLICATIONS

This application claims priority of U.S. provisional application Ser. No. 60/998,418, filed Oct. 9, 2007.

### BACKGROUND OF THE INVENTION

1. Field of Invention

This invention relates to brake warning devices in vehicles, specifically to an improved brake light warning system.

2. Prior Art

For many years, vehicles have been equipped with brake lights that illuminate to warn a following vehicle that the leading vehicle was braking. Originally, brake lights were separate light bulbs with a discrete colored lens. Next, brake lights were incorporated into brake light assemblies that had a brake indicator, turn indicators, and, in some embodiments, reverse indicators. More recently, computers and data buses have been incorporated into vehicles, and the brake light assembly is controlled by a computer-based microcontroller. When a brake signal is sent across the vehicle data bus, the microcontroller associated with the brake assembly illuminates the brake indicator.

There has been a long felt need for more intelligent vehicles that increase vehicle safety. Interjacent Technology Systems of Corralitos, Calif. has developed an expert system called the Interjacent Trip Processor that can be added to a vehicle data bus to provide a highly intelligent vehicle. See Appendix A for more information.

While Interjacent and others have focused on providing a highly intelligent vehicle that aids said vehicle's driver in being a safer driver, there is still a need to alert the following driver that the intelligent vehicle has detected a need to brake before the driver of highly intelligent vehicle actually brakes.

What is needed is a pre-brake indicator that will alert a following driver.

### SUMMARY

In accordance with one embodiment, this invention can prevent a significant number of rear end collisions by alerting a following driver of the need to brake a fraction of a second before the brake light illuminates. A highly intelligent vehicle processor that monitors a variety of inputs could detect the need for the driver to brake by comparing the driver's reaction to that of a virtual competent driver in the same context. Alternatively, the highly intelligent vehicle processor could observe the deceleration of one or more vehicles ahead, for example, using radar or LIDAR. The highly intelligent vehicle processor could send a pre-brake warning signal to the brake light assembly before the driver steps on the brake and sends the conventional brake signal to the brake indicator.

### OBJECTS AND ADVANTAGES

Accordingly, the present invention includes the following advantages:
a) Providing a faster and more reliable means of alerting drivers of a highly intelligent vehicle of the need to brake in response to an obstacle, hazard, or decelerating vehicle ahead.
b) Reducing the number of head-on collisions caused by driver inexperience or inattention by providing an improved system of alerting the driver of obstacles and/or hazards ahead.
c) Providing a two-fold alert system that notifies both the driver of the intelligent vehicle system and a following vehicle of the need to brake in response to obstacles and/or hazards ahead.
d) Providing a system that can be used on various types of transportation vehicles, including but not limited to buses and semi-trailer trucks.
e) Providing a pre-brake warning system that is easily installed in both new and old vehicles (as an after-market add-on).
f) Reducing congestion by providing a safe early alert system that increases the amount of time a driver has to react to hazards ahead.
g) Increasing the driver's comfort level in high traffic situations.

### DRAWINGS—FIGURES

FIG. 1 shows the cross-section of a highly intelligent vehicle with a pre-brake indicator.

FIG. 2A to 2C show alternatives for the brake light assembly with a pre-brake indicator.

FIG. 3 shows a simplified embodiment of a vehicle with a pre-brake indicator.

FIG. 4 shows a sequence of cars responding to an obstacle.

FIGS. 5A and 5B show left and right brake light assembly.

FIGS. 6 and 7, respectively, show alternative brake light assembly with LED arrays.

### REFERENCE NUMERALS

100 brake light assembly
110 pre-brake indicator
111 pre-brake signal
112 brake signal
113 reverse signal
120 brake indicator
122 brake switch
123 reverse switch
130 reverse indicator
140 virtual competent driver
150 highly intelligent vehicle
160 transmission
162 gear shift
170 remote sensing device
180 driver
190 driver warning
200 first brake light assembly
210 second brake light assembly
220 third brake light assembly
230 turn indicator
300 processor
400 obstacle
410 leading car
420 following car
500 signal generation block
501 left brake light assembly
502 right brake light assembly
600 LED array
610 pre-brake color
620 brake color
700 alternate LED array
710 pre-brake section
720 brake section

### DESCRIPTION OF THE INVENTION

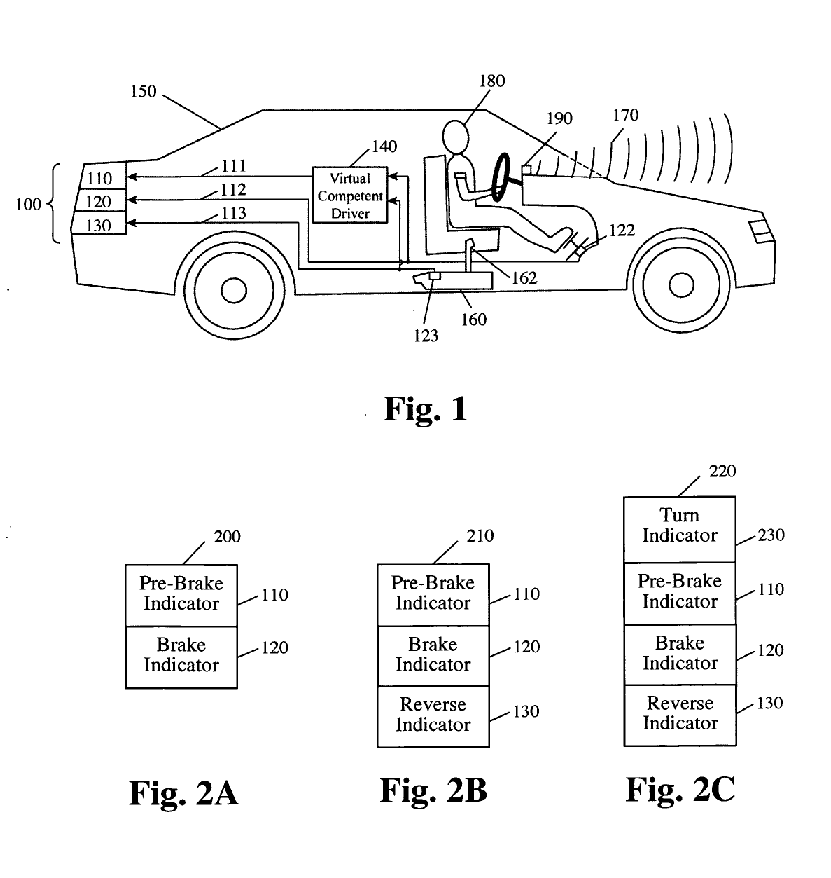

FIG. 1 shows the cross-section of an intelligent vehicle 150 equipped with a remote sensing device 170 (based on RADAR, LIDAR, etc.), a Virtual Competent Driver 140, and a brake light assembly 100. The brake light assembly 100 comprises a pre-brake indicator 110, a brake indicator 120, and a reverse indicator 130. The vehicle also has a brake pedal with a brake switch 122, and a transmission with a gear shift 162 and a reverse switch 123.

A highly intelligent vehicle processor monitors input from a variety of sources—including but not limited to the brake switch 122, the reverse switch 123, the transmission 160, and compares the reactions of the driver 180 of the highly intelligent vehicle to that of a virtual competent driver 140 in the same context. The virtual competent driver can be implemented as a software program, such as the Interjacent expert system. Before the driver 180 steps on the brake switch 122, sending a conventional brake signal 112 to the brake indicator 120, the highly intelligent vehicle processor sends a pre-brake signal 111 to the brake light assembly 100. A driver warning 190 is also sent to the driver (illustrated as an indicator on the dash board of the highly intelligent vehicle 150).

FIGS. 2A to 2C illustrate variations of the brake light assembly 100. First brake light assembly 200 (FIG. 2A) comprises a pre-brake indicator 110 and a brake indicator 120. Second brake light assembly 210 (FIG. 2B) comprises a pre-brake indicator 110, a brake indicator 120, and a reverse indicator 130. Third brake light assembly 220 (FIG. 2C) comprises a pre-brake indicator 110, a brake indicator 120, a reverse indicator 130, and a turn indicator 230.

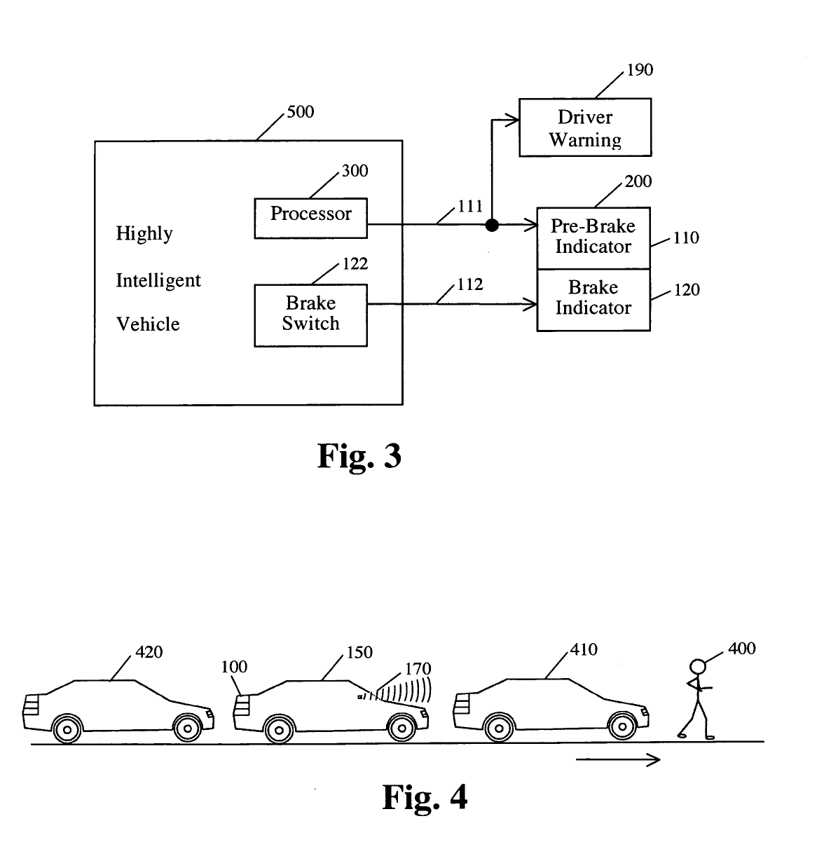

A simple embodiment of the present invention is shown in FIG. 3. In this embodiment, a highly intelligent vehicle comprises at least a processor 300 and a brake switch 122. The processor 300 sends a pre-brake signal 111 to the pre-brake indicator 110 and driver warning 190. The brake switch 122 sends a brake command 112 to the brake indicator 120.

FIG. 4 shows a sequence of vehicles responding to obstacle 400. Upon detecting the presence of obstacle 400, the leading car 410 may respond by either braking or decelerating (with wheel brakes or with engine braking). The highly intelligent vehicle 150 detects the response of the leading car 410 via a remote sensing device 170 and sends a pre-brake signal 111 to the brake light assembly 100. In turn, the pre-brake indicator 110 of the brake light assembly 100 illuminates and is observable by the driver of following car 420. In this way, the driver of the following car 420 is alerted even before the driver of the highly intelligent vehicle presses the brake pedal.

At the same time that the pre-brake signal 111 is sent, the driver warning 190 (as shown in FIG. 3) also is activated. The driver warning 190 could be a visual indicator, audio indicator, or both. The driver warning 190, or the deceleration of the leading car 410, eventually will be noticed by the driver of the highly intelligent vehicle 150, who then will hit the brake pedal. When the brake pedal of vehicle 150 is hit, the normal brake indicator 120 will illuminate.

Thus, in this scenario with this embodiment, the following driver first will see the pre-brake indicator 110 followed by the actual brake indicator 120, giving the following driver valuable seconds to respond, avoiding a collision and its resulting damage and injury.

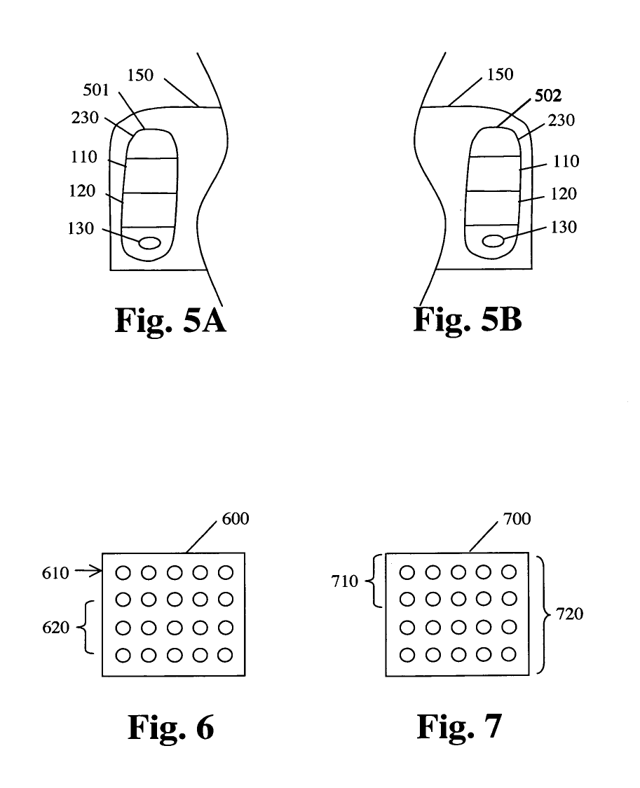

FIGS. 5A and 5B show left and right brake light assemblies, respectively. In FIG. 5A, left brake light assembly 501 comprises a left turn indicator 230, a pre-brake indicator 110, a brake indicator 120, and a reverse indicator 130. In FIG. 5B, right brake light assembly 502 comprises a right turn indicator 230, a pre-brake indicator 110, a brake indicator 120, and a reverse indicator 130. Each of the left and right brake assemblies could be symmetrically designed and could have various shapes and configurations as known in the art, with the addition of my novel pre-brake indicator 110.

FIG. 6 shows a LED array 600 that consists of a row in the array 600 pre-brake color 610, which is a different color than the conventional brake color 620. In this embodiment, for example, the pre-brake color 610 could be blue LEDs while the normal brake color 620 could be red LEDs.

FIG. 7 shows an alternate LED array 700 that consists of a pre-brake section 710 and a brake section 720. In this embodiment, only a small number of LEDs illuminate upon receipt of the pre-brake signal 111. When the brake signal 112 is received, the entire array comprising the pre-brake section 710 and the brake section 720 illuminate. Alternatively, the two sections could alternate.

Other embodiments are also within the scope of the invention; for example, the pre-brake section 710 could also be a different color similar to pre-brake color 610.

### Additional Embodiments

In one embodiment, the lights could have a group of LEDs that illuminate in a predetermined color in response to the pre-brake signal. In an alternate embodiment, a separate light could be used. In yet another embodiment, a quick flash during the pre-brake signal period could be used: solid red on all lights would indicate braking by the driver.

I claim:

1. A brake light assembly comprising:
a) a pre-brake indicator, and
b) a brake indicator.

2. The brake light assembly of claim 1 further comprising:
c) a reverse indicator.

3. The brake light assembly of claim 2 further comprising:
d) a turn indicator.

4. The brake light assembly of claim 1 further comprising:
c) a turn indicator.

5. The brake light assembly of claim 1,
wherein the brake light assembly comprises an LED array having:
i) a pre-brake section, and
ii) a brake section,
wherein the pre-brake indicator is the pre-brake section, and
wherein the brake indicator is the brake section.

6. The brake light assembly of claim 1,
wherein the brake light assembly has a plurality of colors,
wherein the pre-brake indicator has a first color, and
wherein the brake indicator has a second color.

7. The brake light assembly of claim 1 wherein upon receipt of a pre-brake signal the pre-brake indicator activates.

8. The brake light assembly of claim 5 wherein upon receipt of a pre-brake signal the pre-brake section illuminates.

9. The brake light assembly of claim 6 wherein upon receipt of a pre-brake signal the pre-brake indicator illuminates in the first color.

10. The brake light assembly of claim 7 wherein upon receipt of a brake signal the brake indicator illuminates in the second color.

11. The brake light assembly of claim 8 wherein upon receipt of a brake signal the brake indicator illuminates.

12. The brake light assembly of claim 1,
wherein the brake light assembly comprises an LED array comprising a predetermined number of LEDs,
wherein a subset of the predetermined number of LEDs comprise the pre-bake indicators, and
wherein all of the predetermined number of LEDs comprise the brake indicator.

13. The brake light assembly of claim 1,
wherein the pre-brake indicator activates by flashing, and
wherein the brake indicator activates by continuous illumination.

14. A brake light system comprising a plurality of the brake light assemblies of claim 1.

15. The brake light system of claim 14 wherein the brake light assemblies are symmetrical.

16. The brake light system of claim 14 wherein the brake light assemblies have the same shape.

17. A brake light warning system, for using in a vehicle having a brake switch and a processor, said brake light warning system comprising:
a) at least one brake light assembly, each comprising at least:
i) a pre-brake indicator, and
ii) a brake indicator,
b) a driver warning,
c) a means of receiving a pre-brake signal for the pre-brake indicator,
d) a means of receiving a brake signal for the brake indicator.
wherein upon receipt of the pre-brake signal from the processor the pre-brake indicator is activated.

18. A brake light warning system of claim 17,
wherein upon receipt of the pre-brake signal from the processor the driver warning is also activated, and
wherein upon the receipt of the brake signal the brake indicator is activated,
whereby the driver of the vehicle is warned of the need to break prior to breaking, and
whereby the driver of a following vehicle is also warned prior to receipt of the brake signal.
